(19) United States
(12) Patent Application Publication
(10) Pub. No.: US 2023/0378737 A1
(43) Pub. Date: Nov. 23, 2023

(54) INSULATING CROSS ARM AND PREPARATION METHOD THEREOF, AND TRANSMISSION POLE

(71) Applicant: JIANGSU SHEMAR ELECTRIC CO., LTD., Nantong (CN)

(72) Inventors: Bin MA, Nantong (CN); Tianliang JIN, Nantong (CN); Kang XU, Nantong (CN)

(73) Assignee: JIANGSU SHEMAR ELECTRIC CO., LTD., Nantong (CN)

(21) Appl. No.: 17/630,629

(22) PCT Filed: Aug. 20, 2021
(86) PCT No.: PCT/CN2021/113650

§ 371 Date: Oct. 3, 2022

(30) Foreign Application Priority Data
Sep. 4, 2020 (CN) 202010922637.1

(51) Int. Cl. H02G 7/20; E04H 12/24; H01B 17/16

(52) U.S. Cl. CPC H02G 7/205; E04H 12/24; H01B 17/16

(57) ABSTRACT

The present disclosure discloses an insulating cross arm and a preparation method thereof, and a transmission pole. The insulating cross arm includes: an integrally cast connecting fitting including an intermediate connecting part and two sleeves respectively disposed at opposite ends of the intermediate connecting part; a core rod including a first core rod and a second core rod, an end of the first core rod and an end of the second core rod being respectively fixed in the two sleeves; two wire attaching fittings respectively fixed to another end of the first core rod and another end of the second core rod; and an insulating layer coated on and fixed to an outer peripheral surface of the core rod. The insulating layer is located in other regions, and the insulating layer is connected with both the connecting fitting and the wire attaching fittings in a sealing way.

### TECHNICAL FIELD

The present disclosure relates to the field of transmission insulating equipment, and more particularly to an insulating cross arm and a preparation method thereof, and a transmission pole.

### BACKGROUND

In a field of power equipment, an insulating cross arm for transmission lines is an important corollary equipment for transmission poles, it is used to support conductors, lightning conductors, etc., and maintain a certain safe distance as specified. At present, a composite cross arm used in the transmission lines with a voltage level of 35 kV or below mostly adopts integral cross arms with middle fittings sleeved. A core rod of the composite cross arm is a long construction, and some composite cross arms are perforated in the middle of the core rod to pass through a hoop to connect a pole body. Some core rods are not perforated, thus the middle fittings used are more complicated and bulky, which results in an increase of an overall weight of the cross arm and requires double hoops for fixing, with a more complicated installation.

### SUMMARY

In view of the disadvantages of the prior art, the object of the present disclosure is to provide an insulating cross arm and a preparation method thereof, and a transmission pole, which can reduce the weight of the insulating cross arm while ensuring the mechanical strength of the insulating cross arm, simplify the structure and facilitate installation.

In order to achieve the above object of the present disclosure, the present disclosure provides an insulating cross arm including: a connecting fitting including an intermediate connecting part and two sleeves respectively disposed at opposite ends of the intermediate connecting part; a core rod including a first core rod and a second core rod, an end of the first core rod and an end of the second core rod being respectively fixed in the two sleeves; two wire attaching fittings respectively fixed to another end of the first core rod and another end of the second core rod; and an insulating layer coated on and fixed to an outer peripheral surface of the core rod. The insulating layer is located in other regions except the connecting fitting and the wire attaching fittings, and the insulating layer is connected with both the connecting fitting and the wire attaching fittings in a sealing way.

The above insulating cross arm adopts two core rods as a main material for insulating and force-bearing, which are the first core rod and the second core rod respectively. The middle of the insulating cross arm adopts a connecting fitting, and left and right ends of the connecting fitting are respectively sleeved with the first core rod and the second core rod. There is no need to perforate in the core rod or use a complicated connecting device to connect with the pole body. Both ends of the insulating cross arm are sleeved with wire attaching fittings for fixedly connecting the wires. The first core rod and the second core rod are coated with an insulating layer to protect the core rods from aging.

Preferably, the connecting fitting is an integrally cast fitting with simple structure and convenient installation.

Preferably, a block is provided on a side of the intermediate connecting part, and the block has an arched surface recessed toward the inner side of the intermediate connecting part for mating connection with the pole body.

Preferably, the intermediate connecting part is a plate member, the two sleeves respectively extend outward from the opposite ends of the intermediate connecting part in a direction along an axis of the insulating cross arm, and both the two sleeves have a hollow structure for sleeving with the first core rod and the second core rod.

Preferably, a width of the intermediate connecting part is less than a width of the sleeve in a direction perpendicular to a vertical plane where the axis of the insulating cross arm is located, so as to reduce the overall weight of the cross arm while reducing the cost.

Preferably, at least two mounting holes are provided in the intermediate connecting part in a direction along an axis of the insulating cross arm for passing through a pole body connecting member to fixedly connect the cross arm with the pole body.

Preferably, a top-phase platform is provided at an upper end of the intermediate connecting part, and a top-phase hole is provided in the top-phase platform for connecting a top-phase insulator.

Preferably, the sleeve includes a sleeve body and a flange disposed around the sleeve body and connected with the sleeve body. The insulating layer is coated on the flange and a portion of an outer wall of the sleeve body, so as to ensure sealing performance between the insulating layer and the connecting fitting.

Preferably, the intermediate connecting part is provided with a lightening hole to further lighten the entire weight of the insulating cross arm while reducing the cost, and a reinforcing rib is provided in the lightening hole in a direction perpendicular to an axis of the insulating cross arm to ensure the mechanical strength of the intermediate connecting part.

To achieve the above object, another technical solution provided by the present disclosure is as follows: providing a preparation method of an insulating cross arm, including steps of:
forming a first core rod, a second core rod, a connecting fitting, and two wire attaching fittings;
fixedly connecting an end of the first core rod and an end of the second core rod with the connecting fitting, and respectively fixedly connecting another end of the first core rod and another end of the second core rod with the two wire attaching fittings to form a member to be coated; and
integrally coating an insulating layer on the member to be coated, wherein the insulating layer is coated on other regions of the first core rod and the second core rod except the connecting fitting and the wire attaching fittings to obtain the insulating cross arm.

To achieve the above object, another technical solution provided by the present disclosure is as follows: providing another preparation method of an insulating cross arm, including steps of:
forming a core rod preform, a connecting fitting, two wire attaching fittings, and a plurality of insulating sheds;
uniformly coating an outer surface of the core rod preform with an insulating sheath, and cutting the core rod preform to form a first core rod and a second core rod;
respectively fixing the plurality of insulating sheds on the insulating sheath of both the first core rod and the second core rod to form an insulating layer; and
fixedly connecting an end of the first core rod and an end of the second core rod with the connecting fitting, and respectively fixedly connecting another end of the first core rod and another end of the second core rod with the two wire attaching fittings to obtain the insulating cross arm.

To achieve the above object, another technical solution provided by the present disclosure is as follows: providing a transmission pole including a pole body and an insulating cross arm fixed to the pole body, and the insulating cross arm adopting any one of the above insulating cross arms.

Preferably, the insulating cross arm includes a connecting fitting having at least two mounting holes in a direction along an axis of the insulating cross arm, and the transmission pole includes a pole body fixing member that cooperates with the mounting holes to fasten the insulating cross arm onto the pole body.

The present disclosure has the following advantageous effects. Different from the prior art, by fixedly connecting the first core rod and the second core rod at opposite ends of the connecting fitting, the core rod of the cross arm is divided into two parts, whereby it is possible to provide a mounting hole in the connecting fitting directly, and provide a pole body connecting member passing through the mounting hole to connect the cross arm with the pole body, without two or more pole body connecting members. The connecting fitting is an integrally cast fitting with simple structure and convenient installation. In addition, the core rod of the cross arm is coated with the insulating layer except for the connecting fitting and the wire attaching fittings to protect the core rod from aging. The insulating cross arm is simple in overall manufacturing process, high in production efficiency and low in cost. The overall injection provides better sealing performance and fewer processes reduce the labor cost and energy consumption.

### BRIEF DESCRIPTION OF THE DRAWINGS

FIG. 1 is a schematic structural view of an insulating cross arm 10 according to a first embodiment of the present disclosure;

FIG. 2 is an enlarged schematic view of part A in FIG. 1;

FIG. 3 is a schematic structural view of a connecting fitting 110 according to the first embodiment of the present disclosure;

FIG. 4 is a schematic structural view of an insulating cross arm 20 according to a second embodiment of the present disclosure;

FIG. 5 is a schematic structural view of a connecting fitting 210 according to the second embodiment of the present disclosure;

FIG. 6 is a schematic structural view of a transmission pole 01 according to a fifth embodiment of the present disclosure; and

FIG. 7 is a schematic structural view of a transmission pole 02 according to a sixth embodiment of the present disclosure.

### DETAILED DESCRIPTION OF THE EMBODIMENTS

As required, specific embodiments of the present disclosure will be disclosed herein. However, it should be understood that the embodiments disclosed herein are merely exemplary examples of the present disclosure and may be embodied in various forms. Accordingly, specific details disclosed herein are not considered limiting, but merely as a basis for the claims and as a basis for teaching those skilled in the art to differently apply the present disclosure in any appropriate manner in practice, including adopting the various features disclosed herein and in combination with features that may not be expressly disclosed herein.

The term “connect” as used in the present disclosure shall be understood broadly, unless otherwise expressly provided or defined, and it may be directly connected or connected through an intermediary. In description of the present disclosure, it should be understood that orientational or positional relationships represented by directional terms, such as up, down, end, an end etc., are orientational or positional relationships based on the drawings, and are merely for the convenience of describing the present disclosure and simplifying the description, rather than indicating or implying that the device or element is intended to have a particular orientation, or is constructed and operated in a particular orientation, and therefore, should not be interpreted as a limitation of the present disclosure.

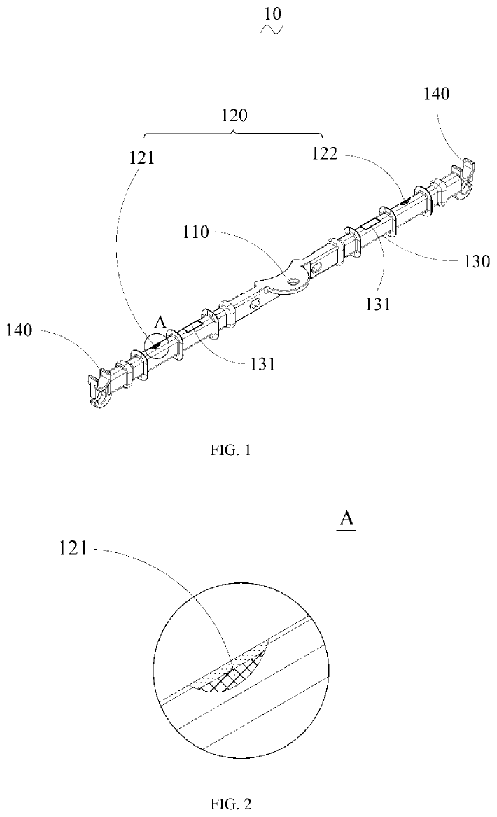

In one embodiment, as shown in FIGS. 1 and 2, an insulating cross arm 10 includes a connecting fitting 110, a core rod 120, an insulating layer 130, and two wire attaching fittings 140. The core rod 120 includes a first core rod 121 and a second core rod 122. An end of the first core rod 121 and an end of the second core rod 122 are respectively fixedly connected with opposite ends of the connecting fitting 110. Another end of the first core rod 121 and another end of the second core rod 122 are respectively fixedly connected with the two wire attaching fittings 140. The core rod 120 is coated with the insulating layer 130. The insulating layer 130 is located in other regions except the connecting fitting 110 and the wire attaching fittings 140. The insulating layer 130 is connected with both the connecting fitting 110 and the wire attaching fittings 140 in a sealing way to protect the core rod 120 from aging.

The core rod 120 is made of a composite material, for example, by impregnating glass fiber or aramid fiber with resin and pultrusion. Compared with the metal materials of the traditional cross arm, the composite material is more corrosion resistant and low in cost, and can reduce a weight of the insulating cross arm 10. A cross-sectional shape of the core rod 120 may be square, circular, T-shaped, or I-shaped. The insulating layer 130 is coated on the core rod 120. The insulating layer 130 is a silicone rubber material, and the silicone rubber material is coated on the outer periphery of the core rod 120 by means of integral injection, so that the cost is low and the efficiency is high. Of course, the coating method may also be a molding process to integrally form the silicone rubber insulating layer. In addition, the silicone rubber material has good aging resistance and transference of hydrophobicity, so that a probability of pollution flashover and rain flashover can be reduced. Of course, the insulating layer 130 may be made of other forms of rubber material.

Furthermore, in the present embodiment, the insulating layer 130 further includes a sheath and a plurality of sheds provided on the sheath and spaced from each other. Upper and lower surfaces of the insulating layer 130 are arc-shaped. When rainwater falls on the insulating layer 130, the rainwater drops along with the surface of the arc-shaped silicone rubber, which facilitates drainage and prevents the electrical performance of the surface of the insulating layer 130 from being affected by water accumulation. Furthermore, the upper and lower surfaces of the insulating layer 130 coated on the outer periphery of the first core rod 121 are symmetrically provided with two grooves 131 (only the grooves 131 on the upper surface are shown in the figure) along an axis of the insulating cross arm 10. The surfaces of the grooves 131 are planar, so that a jumper insulator (not shown in the figure) is conveniently clamped, and an arrangement of the grooves 131 can serve as an indicator for reminding an installer that the jumper insulator can be installed at the grooves 131. Similarly, upper and lower surfaces of the insulating layer 130 coated on the outer periphery of the second core rod 122 are symmetrically provided with two grooves 131 along the axis of the insulating cross arm 10. Preferably, the groove 131 located on the insulating layer 130 of the first core rod 121 and the groove 131 located on the insulating layer 130 of the second core rod 122 are disposed symmetrically on both sides of the connecting fitting 110.

The wire attaching fitting 140 is used for fixing the wire, and the wire can be fixed on the wire attaching fitting 140 through a binding process, or the wire can be fixed by providing a gland. The specific structure of the wire attaching fitting 140 is not limited herein. In addition, the connecting fitting 110 and the wire attaching fitting 140 may be made of a metal material or a composite material, and the metal material may be iron, steel, aluminum, or the like.

In one embodiment, as shown in FIGS. 1 and 3, the connecting fitting 110 is an integrally cast fitting, the overall structure is simple, the molding mode is relatively easy, any complex structure can be molded at one time, thus the process is simple, the efficiency is high, and the designability is strong. The connecting fitting 110 includes an intermediate connecting part 111 and two sleeves 112 respectively provided at opposite ends of the intermediate connecting part 111. The intermediate connecting part 111 is a plate member, and the two sleeves 112 respectively extend outward from the opposite ends of the intermediate connecting part 111 in a direction along an axis of the insulating cross arm 10. That is, the intermediate connecting part 111 is integrally formed with the sleeves 112, and both the two sleeves 112 are of a hollow structure. One end of the first core rod 121 and one end of the second core rod 122 are respectively located in cavities of the two sleeves 112, and then the core rod 120 and the sleeves 112 are fixed by a crimping process. Of course, the core rod 120 and the sleeves 112 may be fixed by glue as long as the core rod 120 and the sleeves 112 can be firmly connected. The cavity of the sleeve 112 has an arbitrary shape, such as square, circular, T-shaped, or I-shaped, and only needs to conform to the cross-sectional shape of the core rod 120. In this way, a contact area between the core rod 120 and the sleeve 112 can be increased as much as possible, so that the connection is more stable, and the mechanical performance of the insulating cross arm 10 is improved.

In another embodiment, a block 113 is provided on a side of the intermediate connecting part 111. That is, the block 113 extends outward from a side of the intermediate connecting part 111. An upper end surface of the block 113 and an upper end surface of the intermediate connecting part 111 are located in the same plane, and a lower end surface of the block 113 and a lower end surface of the intermediate connecting part 111 are located in the same plane, so that a proper contact area is maintained when the connecting fitting 110 is connected with the pole body, thereby making the connection between the insulating cross arm 10 and the pole body more stable. Of course, the upper end surface of the block 113 may be higher or lower than the upper end surface of the intermediate connecting part 111, and the lower end surface of the block 113 may be higher or lower than the lower end surface of the intermediate connecting part 111 as long as the connecting fitting 110 can be brought into contact with the pole body. The block 113 has an arched surface recessed toward an inner side of the intermediate connecting part 111 for mating connection with the pole body, so that the connection is more stable and reliable. In this embodiment, the recessed surface of the block 113 is arched. In other embodiments, the recessed surface of the block 113 may be triangular or rectangular as long as it can match the pole body of corresponding shape. The intermediate connecting part 111 is provided with two first mounting holes 115 in the direction along the axis of the insulating cross arm 10. The two first mounting holes 115 are located at the two ends of the intermediate connecting part 111, and are located at the two sides of the block 113. That is, the block 113 is located between the two first mounting holes 115. The two first mounting holes 115 are used to pass through the pole body connecting member and facilitate the mounting operation. The pole body connecting member is generally a combination of a hoop and nuts, so that the insulating cross arm 10 is fixedly connected with the pole body.

In yet another embodiment, a top-phase platform 114 is provided at the upper end of the intermediate connecting part 111, and the top-phase platform 114 is a curved plate. Specifically, the top-phase platform 114 is perpendicular to the other side of the intermediate connecting part 111, i.e., a back surface of one side of the intermediate connecting part 111 in which the block 113 is located, and the top-phase platform 114 is also located between the two first mounting holes 115. The upper end surface of the top-phase platform 114 and the upper end surface of the intermediate connecting part 111 are located in the same plane. Of course, the upper end surface of the top-phase platform 114 may not be located on the same plane as the upper end surface of the intermediate connecting part 111 as long as the top-phase platform 114 is firmly provided on the intermediate connecting part 111. The top-phase platform 114 is also provided with a top-phase hole 116 for connecting top-phase insulators to adapt to the wire support of single circuit transmission line. Of course, the top-phase platform 114 may also be a rectangular plate or a semicircular plate or other plate of any shape.

In other embodiment, the intermediate connecting part 111 may be provided with no top-phase platform, when used for wire support of a double circuit transmission line. In this case, three insulating cross arms 10 may be mounted on the transmission pole at the same time. Of course, it may also be used for wire support of a single circuit transmission line in which two insulating cross arms are mounted on the transmission pole, one using the insulating cross arm 10 and the other one connecting the first core rod 121 and the wire attaching fitting 140 only on one side of the connecting fitting 110.

Further, in a direction perpendicular to a vertical plane where the axis of the insulating cross arm 10 is located, a width of the intermediate connecting part 111 is less than a width of the sleeve 112. Specifically, on the side of the intermediate connecting part 111 in which the block 113 is located, portions on both sides of the block 113 are recessed toward the inside of the intermediate connecting part 111 to form a groove. On the side of the intermediate connecting part 111 where the top-phase platform 114 is located, a portion between two first mounting holes 115 is recessed toward the inside of the intermediate connecting part 111 to form a groove for reducing the weight of the insulating cross arm 10 and reducing the cost. In addition, the intermediate connecting part 111 provided with the first mounting hole 115 is provided with a groove on only one side to ensure the mechanical strength of the connecting fitting 110 and prevent the connecting fitting 110 from being damaged during operation.

Further, the sleeve 112 includes a sleeve body 117 and a flange 118 disposed around the sleeve body 117 and connected with the sleeve body 117. The insulating layer 130 is coated on the flange 118 and a portion of the outer wall of the sleeve body 117, so as to ensure a sealed connection between the insulating layer 130 and the connecting fitting 110. Specifically, when the core rod 120 and the connecting fitting 110 are sleeved, a gap is formed between the flange 118 and the core rod 120. When the insulating layer 130 is coated on the insulating cross arm 10, the gap can be filled, and the insulating layer 130 is even coated on the portion of the outer wall of the sleeve body 117, so as to better ensure an interface seal between the connecting fitting 110 and the core rod 120, prevent moisture from entering the core rod 120 and corroding the core rod 120, thereby avoiding lowering the mechanical and electrical properties of the core rod 120.

In addition, a connection mode between the wire attaching fitting 140 and the core rod 120 and a connection mode between the connecting fitting 110 and the core rod 120 are consistent, and details are not described herein. The end of the wire attaching fitting 140 also includes a sleeve body and a flange (not shown in the figure) provided around the sleeve body and connected with the sleeve body, so that the insulating layer 130 is coated on the connection interface between the core rod 120 and the wire attaching fitting 140, thereby ensuring the seal between the core rod 120 and the wire attaching fitting 140, preventing moisture from entering the core rod 120 and corroding the core rod 120, thereby avoiding lowering the mechanical and electrical properties of the core rod 120.

The insulating cross arm 10 provided in this embodiment adopts two core rods as a main material for insulating and force-bearing, which are the first core rod 121 and the second core rod 122 respectively. The middle of the insulating cross arm 10 adopts a connecting fitting 110, and left and right ends of the connecting fitting 110 are respectively sleeved with the first core rod 121 and the second core rod 122, whereby a mounting hole can be directly formed in the connecting fitting 110, without perforating a hole in the core rod 120 or using a connecting device with a complicated structure, so that the insulating cross arm 10 can be connected with the pole body without two or more pole body connecting members, thereby simplifying the mounting process of the insulating cross arm 10 and improving the working efficiency. The connecting fitting 110 is integrally cast fitting, the overall structure is simple, the molding mode is relatively easy, any complex structure can be molded at one time, thus the process is simple, the efficiency is high, and the designability is strong. In addition, both ends of the insulating cross arm 10 are sleeved with the wire attaching fittings 140 for fixedly connecting the wires, and a portion of the insulating cross arm 10 other than the connecting fitting 110 and the end wire attaching fittings 140 is coated with the insulating layer 130 to protect the core rod 120 from aging. Compared with the prior art, the insulating cross arm 10 has a reduced material consumption, a simple process, a reduced cost, and is suitable for a variety of poles.

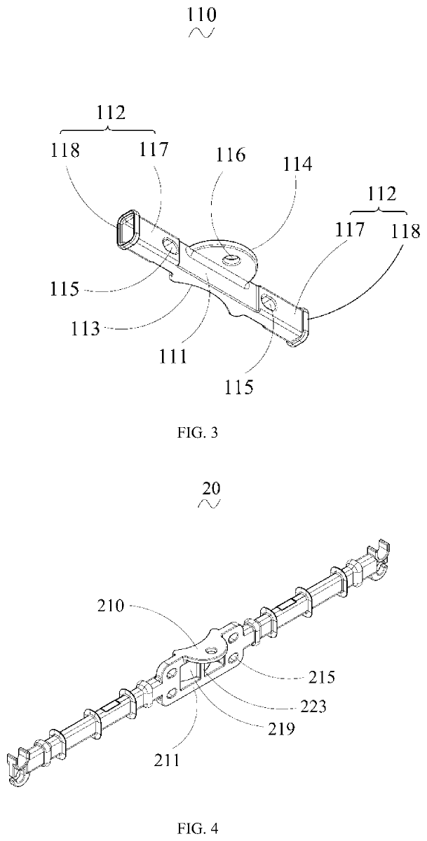

In another embodiment, as shown in FIG. 4, four first mounting holes 215 are symmetrically formed in the intermediate connecting part 211 of the connecting fitting 210 of the insulating cross arm 20 along an axis of the insulating cross arm 20. That is, the four first mounting holes 215 are rectangular in distribution, i.e., the four first mounting holes 215 are respectively positioned at four vertices of the intermediate connecting part 211, so that the insulating cross arm 20 is fixedly connected with the pole body through two pole body connecting members. In this manner, the insulating cross arm 20 can be more firmly connected and has higher mechanical strength.

In an embodiment, the intermediate connecting part 211 is provided with a lightening hole 219 to further lighten the entire weight of the insulating cross arm 20 while reducing the cost. The lightening hole 219 is further provided with a reinforcing rib 223. The reinforcing rib 223 is arranged in a direction parallel to a vertical plane along the axis of the insulating cross arm 20, and may be perpendicular to the axis of the insulating cross arm 20, or may be arranged along the axis of the insulating cross arm 20, so as to ensure mechanical strength of the intermediate connecting part 211 and prevent damage of the connecting fitting 210 during operation. It is preferable that the reinforcing rib 223 is arranged perpendicular to the axis of the insulating cross arm 20. One or a plurality of reinforcing ribs 223 may be provided, and the reinforcing ribs 223 may be designed according to the size of the lightening hole 219 as long as the mechanical strength of the intermediate connecting part 211 is ensured. Preferably, the four first mounting holes 215 are provided on the outer periphery of the lightening hole 219 so that the connecting fitting 210 ensures mechanical strength while reducing weight.

In yet another embodiment, as shown in FIGS. 4 and 5, since the intermediate connecting part 211 is provided with the lightening hole 219, the number of blocks 213 is two, i.e., a first block 224 and a second block 225, the first block 224 is located at the upper end of the intermediate connecting part 211, the second block 225 is located at the lower end of the intermediate connecting part 211, (i.e., the upper end surface of the first block 224 and the upper end surface of the intermediate connecting part 211 are located in the same plane, and the lower end surface of the second block 225 and the lower end surface of the intermediate connecting part 211 are located in the same plane), and the overall weight of the insulating cross arm 20 and the cost are further reduced. Of course, the upper end surface of the first block 224 may be higher or lower than the upper end surface of the intermediate connecting part 211, and the lower end surface of the second block 225 may be higher or lower than the lower end surface of the intermediate connecting part 211 as long as the connecting fitting 210 can be brought into contact with the pole body. The lower end surface of the first block 224 is flush with the upper inner wall of the lightening hole 219, and the upper end surface of the second block 225 is flush with the lower inner wall of the lightening hole 219, thereby minimizing the weight of the entire insulating cross arm 20, reducing the cost, ensuring the mechanical strength between the block 213 and the intermediate connecting part 211, ensuring the contact area between the connecting fitting 110 and the pole body, and enabling a stable connection between the connecting fitting 110 and the pole body.

The insulating cross arm 20 provided in this embodiment has similar advantages to those of the insulating cross arm 10, and will not be described herein again. In addition, the insulating cross arm 20 is connected with the pole body by using two pole body connecting members, so that the insulating cross arm 20 has higher overall mechanical strength and more stable connection, and by providing the lightening holes 219, the amount of material used can be reduced to the greatest extent, thereby reducing the cost.

In yet another embodiment, in combination with FIG. 1, a preparation method of the insulating cross arm 10 includes the following steps.

In step S101, a first core rod 121, a second core rod 122, a connecting fitting 110, and two wire attaching fittings 140 are formed.

The glass fiber impregnated with epoxy resin is pultruded to form the first core rod 121 and the second core rod 122. Of course, the first core rod 121 and the second core rod 122 may also be formed by mould pressing or other molding methods. Preferably, the first core rod 121 and the second core rod 122 may be pultruded by a pultruded process. The resulted first core rod 121 and the second core rod 122 have better mechanical and electrical properties and lower cost. In addition, shapes of the first core rod 121 and the second core rod 122 may be circular, square, T-shaped, or I-shaped.

Both the connecting fitting 110 and the two wire attaching fittings 140 are formed in one-time casting method. When the material of the connecting fitting 110 and the wire attaching fittings 140 is cast iron, the connecting fitting 110 and the wire attaching fittings 140 shall be hot-galvanized to prevent corrosion of the fittings and prolong the service life. This operation is not required when the material of the connecting fitting 110 and the wire attaching fittings 140 is cast aluminum. Of course, the connecting fitting 110 may also be formed by a forging process, which is not limited herein. When the connecting fitting 110 and wire attaching fittings 140 are formed in one-time casting method, the overall structure is simple, the molding mode is relatively easy, any complex structure can be molded at one time, thus the process is simple, the efficiency is high, and the designability is strong.

In step S102, an end of the first core rod 121 and an end of the second core rod 122 are respectively fixedly connected with the connecting fitting 110, and another end of the first core rod 121 and another end of the second core rod 122 are respectively fixedly connected with the two wire attaching fittings 140 to form a member to be coated.

The first core rod 121 and the second core rod 122 are fixedly connected with the connecting fitting 110 and the wire attaching fitting 140 by a crimping method. The connection is reliable, the process is simple, the production efficiency is high, and the cost is low. In order to further ensure the sealing of the interface between the first core rod 121 and the second core rod 122 and the connecting fitting 110 and the wire attaching fittings 140, a sealing ring may be placed at both ends of the first core rod 121 and the second core rod 122 before the first core rod 121 and the second core rod 122 are crimped with the connecting fitting 110 and the wire attaching fittings 140.

In this embodiment, the first core rod 121 and the second core rod 122 are fixed with the connecting fitting 110 and the wire attaching fittings 140 by crimping. In other embodiments, the first core rod 121 and the second core rod 122 may be fixed with the connecting fitting 110 and the wire attaching fittings 140 by glue. Specifically, when the glue is used for fixing, glue is coated in the cavity of the sleeve 112 of the connecting fitting 110, and then fastened at the end of the first core rod 121 and the end of the second core rod 122. One end of each of the wire attaching fittings 140 is also provided with a sleeve. The inner wall cavity of the sleeve at the end of each of the wire attaching fittings 140 is coated with glue and fastened at the other end of the first core rod 121 and the other end of the second core rod 122, respectively. The first core rod 121 and the second core rod 122 are respectively fixedly connected with the connecting fitting 110 and the two wire attaching fittings 140 by curing. Alternatively, after the connecting fitting 110 is fastened to the end of the first core rod 121 and the end of the second core rod 122, a glue injection hole is provided at the end of the connecting fitting 110 to inject glue, and finally, the first core rod 121 and the second core rod 122 are fixedly connected with the connecting fitting 110 by curing, and the connection of the wire attaching fitting 140 is similarly performed, which is not described herein.

In step S103, an insulating layer 130 is integrally coated on the member to be coated. The insulating layer 130 is coated on other regions of the first core rod 121 and the second core rod 122 except the connecting fitting 110 and the wire attaching fittings 140 to obtain the insulating cross arm 10.

The insulating layer 130 is preferably a silicone rubber material, which has good aging resistance and transference of hydrophobicity, so that it can significantly prevent occurrence of pollution flashover and rain flashover. Of course, the insulating layer 130 may be made of other forms of rubber material. The coating method adopts an integral injection process, which is low in cost and high in efficiency. Before the integral injection of the insulating layer 130, a coupling agent is coated on the first core rod 121 and the second core rod 122, so that an adhesive performance between the silicone rubber and the first core rod 121 and the second core rod 122 is better. Since the integral injection process is employed, the insulating layer 130 naturally forms a sealed connection with the connecting fitting 110 and the wire attaching fittings 140 after the injection molding. Of course, the coating method may also be a molding process to integrally form the silicone rubber insulating layer.

The preparation method of the insulating cross arm 10 provided in this embodiment can also be used to prepare the insulating cross arm 20. The overall process steps are few, the process is simple, the cost of pultrusion and one-time crimping is low, and the labor cost and energy consumption can be reduced. The overall injection provides better sealing performance, and the silicone rubber insulating layer 130 makes the insulating cross arm 10 have better external insulating performance and aging resistance.

In other embodiment, in combination with FIG. 1, another preparation method of the insulating cross arm 10 includes the following steps.

In step S201, a core rod preform, a connecting fitting 110, two wire attaching fittings 140, and a plurality of insulating sheds are formed.

The molding mode of the core rod preform, the connecting fitting 110 and the two wire attaching fittings 140 is similar to the above-described step S101, and will not be described herein. In this embodiment, the core rod preform is a relatively long product to be cut and used.

The insulating shed may be a silicone rubber shed or another rubber shed. In this embodiment, silicone rubber insulating sheds in the form of several monolithic sheets are formed by high-temperature vulcanization.

In step S202, an outer surface of the core rod preform is uniformly coated with an insulating sheath of equal thickness, and the core rod preform is cut to form a first core rod 121 and a second core rod 122 coated with the insulating sheath. Inner cavities of a plurality of monolithic insulating sheds are uniformly coated with glue, and then the insulating sheds are placed on the insulating sheath of the first core rod 121 and the second core rod 122 in a certain arrangement order, and the insulating sheath and the insulating sheds together form an insulating layer 130.

The insulating sheath is coated onto the outer surface of the core rod preform by extrusion. In this embodiment, the insulating sheath is a silicone rubber sheath. In other embodiments, the insulating sheath may be a sheath made of other rubber materials. After coating the insulating sheath, the first core rod 121 and the second core rod 122 can be cut in a desired length.

After the monolithic silicone rubber shed is coated with glue, namely adhesive, it is fixed to the silicone rubber sheath through a through hole in the middle of the silicone rubber shed to form a continuous silicone rubber shed.

In step S203, an end of the first core rod 121 and an end of the second core rod 122 are respectively fixedly connected with the connecting fitting 110, and another end of the first core rod 121 and another end of the second core rod 122 are respectively fixedly connected with the two wire attaching fittings 140 to obtain an insulating cross arm 10.

Specifically, after trimming the ends of the first core rod 121 and the second core rod 122 coated with the insulating layer 130, the ends of the first core rod 121 and the second core rod 122 are respectively fixedly connected with the connecting fitting 110 and the wire attaching fittings 140 in a manner similar to the above-described step S102, and will not be described herein again.

In step S204, glue is applied to an interface connection between the first core rod 121 and the second core rod 122 and the connecting fitting 110 and the wire attachment connecting fittings 140.

The interface connection above includes a crimping point where the two ends of the first core rod 121 are respectively connected with the connecting fitting 110 and the wire attaching fitting 140, and a crimping point where the two ends of the second core rod 122 are respectively connected with the connecting fitting 110 and the wire attaching fitting 140. The interface connection is coated with a room temperature vulcanized silicone rubber, and the interface connection is allowed to stand and solidify to form a seal, thereby further improving the sealing effect.

The preparation method of the insulating cross arm 10 provided in this embodiment can also be used to prepare the insulating cross arm 20. A difference from the foregoing preparation method lies in a molding process of the silicone rubber shed. The molding process of this embodiment is referred to as an extrusion-wrapping shed. In this process, the relatively long core rod preform is extruded and connected with the silicone rubber to form the silicone rubber sheath to be coated on the outer surface of the core rod preform, so that the silicone rubber sheath is coated continuously and uniformly, and the interface performance between the core rod preform and the silicone rubber sheath is good. The core rod preform is then cut to form the first core rod 121 and the second core rod 122 of a desired length, and then a silicone rubber shed is worn over the first core rod 121 and the second core rod 122 coated with a silicone rubber sheath to form an insulating layer 130, which improves production efficiency and reduces costs.

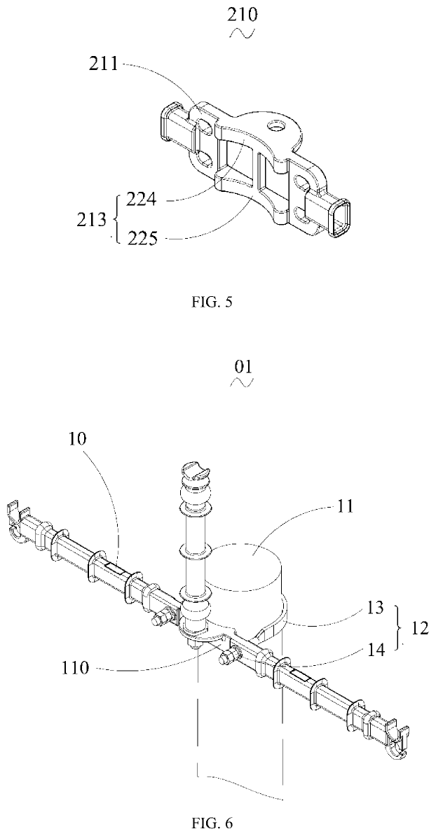

In one embodiment, as shown in FIG. 6, a transmission pole 01 includes a pole body 11, an insulating cross arm 10 fixed to the pole body 11, and a pole body fixing member 12. The insulating cross arm 10 further includes a connecting fitting 110 having two first mounting holes (not shown) in a direction along an axis of the insulating cross arm 10. The pole body fixing member 12 includes a U-shaped hoop 13 and fasteners 14. The fastener 14 includes a matching nut and a flat washer. The U-shaped hoop 13 and the fasteners 14 fasten the insulating cross arm 10 onto the pole body 11 through the two first mounting holes. A metal insert (not shown) may be provided in the first mounting hole. The metal insert has a cylindrical main body, and its size matches the size of the first mounting hole, so as to ensure accurate mounting of the metal insert. The metal insert further includes a flange at one end of the metal insert main body and having an angle of 90° with the main body of the metal insert, so as to prevent the pole body fixing member 12 from causing wear on the outer surface of the connecting fitting 110, and facilitate mounting, so as to ensure stable connection between the insulating cross arm 10 and the pole body 11. The insulating cross arm 10 further includes a top-phase platform arranged on the connecting fitting 110, and a top-phase insulator is vertically fixed on the top-phase platform, so that three-phase wires can be attached.

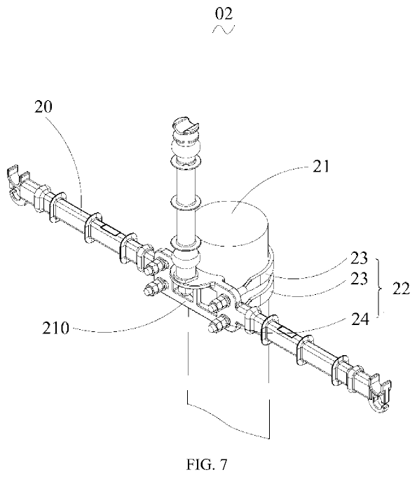

In another embodiment, as shown in FIG. 7, a transmission pole 02 includes an insulating cross arm 20. The insulating cross arm 20 includes a connecting fitting 210, and four first mounting holes (not shown) are symmetrically formed on the connecting fitting 210 along an axis of the insulating cross arm 20. That is, the four first mounting holes are rectangular in distribution. The transmission pole 02 further includes a pole body 21 and a pole body fixing member 22. The pole body fixing member 22 includes two U-shaped hoops 23 and fasteners 24. The fastener 24 includes a matching nut and a flat washer. The two U-shaped hoops 23 and the fasteners 24 fix the insulating cross arm 20 to the pole body 21 through the four first mounting holes. A metal insert (not shown) may be provided in the four first mounting holes. The metal insert has a cylindrical main body, and its size matches the size of the first mounting hole, so as to ensure accurate mounting of the metal insert. The metal insert further includes a flange at one end of the metal insert main body and having an angle of 90° with the main body of the metal insert, so as to prevent the pole body fixing member 22 from causing wear on the outer surface of the connecting fitting 210, and facilitate mounting, so as to ensure stable connection between the insulating cross arm 20 and the pole body 21.

The technical content and technical features of the present disclosure have been disclosed as above, however, it will be understood that under the inventive concept of the present disclosure, various changes and improvements in the above-mentioned structures and materials may be made by those skilled in the art, including combinations of technical features disclosed or claimed herein alone, including obviously other combinations of these features. These variations and/or combinations fall within the technical field of the present disclosure and fall within the scope of the claims of the present disclosure.

1. An insulating cross arm, comprising:
a connecting fitting comprising an intermediate connecting part and two sleeves respectively disposed at opposite ends of the intermediate connecting part;
a core rod comprising a first core rod and a second core rod, an end of the first core rod and an end of the second core rod being respectively fixed in the two sleeves;
two wire attaching fittings respectively fixed to another end of the first core rod and another end of the second core rod; and
an insulating layer coated on and fixed to an outer peripheral surface of the core rod, wherein the insulating layer is located in other regions except the connecting fitting and the wire attaching fittings, and the insulating layer is connected with both the connecting fitting and the wire attaching fittings in a sealing way.

2. The insulating cross arm according to claim 1, wherein the connecting fitting is an integrally cast fitting.

3. The insulating cross arm according to claim 1, wherein a block is provided on a side of the intermediate connecting part, and the block has an arched surface recessed toward an inner side of the intermediate connecting part.

4. The insulating cross arm according to claim 1, wherein the intermediate connecting part is a plate member, the two sleeves respectively extend outward from the opposite ends of the intermediate connecting part in a direction along an axis of the insulating cross arm, and both the two sleeves have a hollow structure.

5. The insulating cross arm of claim 4, wherein a width of the intermediate connecting part is less than a width of the sleeve in a direction perpendicular to a vertical plane where the axis of the insulating cross arm is located.

6. The insulating cross arm according to claim 1, wherein at least two mounting holes are provided in the intermediate connecting part in a direction along an axis of the insulating cross arm.

7. The insulating cross arm according to claim 1, wherein a top-phase platform is provided at an upper end of the intermediate connecting part, and a top-phase hole is provided in the top-phase platform.

8. The insulating cross arm of claim 1, wherein the sleeve comprises a sleeve body and a flange disposed around the sleeve body and connected with the sleeve body, and the insulating layer is coated on the flange and a portion of an outer wall of the sleeve body.

9. The insulating cross arm according to claim 1, wherein a lightening hole is provided in the intermediate connecting part, and a reinforcing rib is provided in the lightening hole in a direction perpendicular to an axis of the insulating cross arm.

10. A preparation method for an insulating cross arm, comprising:
forming a first core rod, a second core rod, a connecting fitting, and two wire attaching fittings;
fixedly connecting an end of the first core rod and an end of the second core rod with the connecting fitting, and respectively fixedly connecting another end of the first core rod and another end of the second core rod with the two wire attaching fittings to form a member to be coated; and
integrally coating an insulating layer on the member to be coated, wherein the insulating layer is coated on other regions of the first core rod and the second core rod except the connecting fitting and the wire attaching fittings to obtain the insulating cross arm.

11. A preparation method for an insulating cross arm, comprising steps of:
forming a core rod preform, a connecting fitting, two wire attaching fittings, and a plurality of insulating sheds;
uniformly coating an outer surface of the core rod preform with an insulating sheath, and cutting the core rod preform to form a first core rod and a second core rod;
respectively fixing the plurality of insulating sheds on the insulating sheath of both the first core rod and the second core rod to form an insulating layer; and
fixedly connecting an end of the first core rod and an end of the second core rod with the connecting fitting, and respectively fixedly connecting another end of the first core rod and another end of the second core rod with the two wire attaching fittings to obtain the insulating cross arm.

12. A transmission pole comprising a pole body and an insulating cross arm fixed to the pole body, wherein the insulating cross arm adopts the insulating cross arm according to claim 1.

13. The transmission pole of claim 12, wherein the insulating cross arm comprises a connecting fitting having at least two mounting holes in a direction along an axis of the insulating cross arm, and the transmission pole comprises a pole body connecting member that cooperates with the mounting holes to fasten the insulating cross arm onto the pole body.
